(19) United States
(12) Patent Application Publication
(10) Pub. No.: US 2017/0038036 A1
(43) Pub. Date: Feb. 9, 2017

(54) COVER FOR LED STRIPS

(71) Applicant: Salvatore Guerrieri, New York, NY (US)

(72) Inventor: Salvatore Guerrieri, New York, NY (US)

(21) Appl. No.: 15/227,088

(22) Filed: Aug. 3, 2016

Related U.S. Application Data
(60) Provisional application No. 62/200,634, filed on Aug. 3, 2015.

(51) Int. Cl. F21V 15/01; F21S 4/24

(52) U.S. Cl. CPC F21V 15/012; F21S 4/24; F21Y 2103/10

(57) ABSTRACT

An LED lighting system is described that is comprised of an LED ribbon strip having LEDs to emit light and an LED lighting cover having a top section, an internal channel and a cavity; wherein said internal channel will house the LED strip; said cavity will be located in the top section and positioned above the internal channel such that the LEDs being housed in said internal channel will emit the light to enter the cavity and shine through the top section of the LED lighting cover. The LED lighting system as recited in claim 16 further comprising a sleeve; said sleeve being flexible and encapsulates said LED ribbon strip in an interior channel; said interior channel large enough to allow said LED ribbon strip to twist within said interior channel when said sleeve is flex from side to side.

### CROSS-REFERENCE TO RELATED APPLICATIONS

This application relates to and claims priority rights from U.S. Provisional Application Ser. No. 62-200634 filed on Aug. 3, 2015, the entire disclosure of which are hereby incorporated by reference herein.

### BACKGROUND OF THE INVENTION

Field of the Invention

The present disclosure relates to covers for an LED lighting ribbon strip.

Description of the Related Art

LED lighting has become a popular way of providing light. Small in size, an LED can emit light in different colors and luminosity. It has been used to replace regular lighting such as fluorescent or incandescent lights because using LEDs provide numerous advantages over traditional light bulbs. For example, the size of the LED is dramatically smaller than a typical incandescent bulb, but the luminance of the LED can be just as strong or even greater.

With the smaller size of the LED chip, there is more freedom in designing LED based light fixtures. Additionally, LED lighting designs can be more flexible than traditional lamps since a glass cover is not necessary to protect the filament or to contain a gas. That added flexibility allows LEDs to be utilized on many different substrates with many advantages since any control unit that will monitor the power supplied, the light output and/or heat properties can also be remotely located from the LED device located on the substrate. One type of substrate that houses an LED lighting fixture utilizes a ribbon substrate.

A flexible ribbon substrate is usually a thin material that will house the LEDs on top and have the ability to conduct electrical signals through the substrate that will power and control the LEDS. The ribbon substrate typically only houses electrical wiring to the LEDs and minor supporting electrical components and consequently will be as flexible as an electrical wire. The thin substrate will usually have a flat surface upon which the LEDs are mounted. The thin material allows the substrate to be used in many different situations whereby a thin profile is necessary. Situations such as having lighting nearly flush against a wall are well suited to such a product.

Having a thin material as the substrate, however, has the disadvantages of being more fragile and prone to tearing, particularly if the substrate is bent from side to side. The thin material will be fully capable of being rolled up as tape would be rolled up, but if the thin substrate is bent to either side, then the substrate is more vulnerable to tearing. It would be advantageous if the ribbon lighting system were flexible yet not be susceptible to tears or to developing a kink when being bent which could weaken the structure.

In addition, since the LEDs are individual components that are placed on the thin substrate, the light emanating from the LEDs will be perceived as individual points of light. It would be advantageous if the ribbon lighting structure were flexible yet still able to emit a consistent glow throughout the surface of the fixture and not see the points of light from the individual LED themselves.

### SUMMARY OF THE INVENTION

The above objects of the invention and advantages are achieved by having a cover system that is flexible but durable. The cover allows the ribbon lighting substrate to remain flexible, but will protect the LED ribbon strip from breaking or tearing. The cover will also create a uniform glow throughout the surface of the cover such that a viewer will only see a continuous glow of light emanating from the cover without any points of light.

The lighting system will provide a flexible, but sturdy covering that will fit over the LED ribbon substrate. The cover will have an internal channel that will accommodate the LED ribbon strip. The LED ribbon strip can be further encased in a sleeve before insertion into the channel The cover will be composed of a material that is flexible and strong such as silicone to protect the LED ribbon strip while allowing it to be curved. The cover will be capable of curving in all different directions, but will spread the curve gradually throughout the length of the cover and not bend or kink in one place. The thickness of the walls will also promote curvature of the LED strip in desired directions as well.

The covering will be a translucent material which will slightly refract and diffuse the LED lights. The covering will also have an internal cavity that is located above LEDs on the strip. The cavity will allow the light from the individual LEDS to mix and create a uniform light in the cavity that will appear uniform to the outside viewer.

### BRIEF DESCRIPTION OF THE DRAWINGS

FIG. 1 depicts a perspective view of the LED lighting system in accordance with one embodiment of the present invention.

FIGS. 2a and 2b depict the mounting bracket and mounting channel components of the LED Lighting System in accordance with one embodiment of the present invention.

FIG. 3 depicts a top view of the LED lighting unit in accordance with one embodiment of the present invention.

FIG. 4 depicts the LED ribbon strip component in accordance with one embodiment of the present invention.

FIG. 5 depicts a different configuration of the LED ribbon strip component in accordance with another embodiment of the present invention.

FIG. 6 depicts the LED ribbon strip component encased in a sleeve in accordance with one embodiment of the present invention.

FIGS. 7a and 7b depict a perspective view and a side view of the sleeve component in accordance with one embodiment of the present invention.

FIGS. 8a and 8b depict a perspective view and a side view of the LED lighting cover in accordance with one embodiment of the present invention.

FIGS. 9a-d depicts different embodiments of the LED lighting cover.

FIG. 10 depicts the flexibility of the LED lighting cover in accordance with one embodiment of the present invention.

### DETAILED DESCRIPTION OF THE EMBODIMENTS

For the purposes of understanding the invention, reference will now be made to the embodiments illustrated in the drawings. It will be understood that no limitation of the scope of the invention is thereby intended. Any alterations and further modifications in the described embodiments, and any further applications of the principles of the invention as described herein are contemplated as would normally occur to one skilled in the art to which the invention relates.

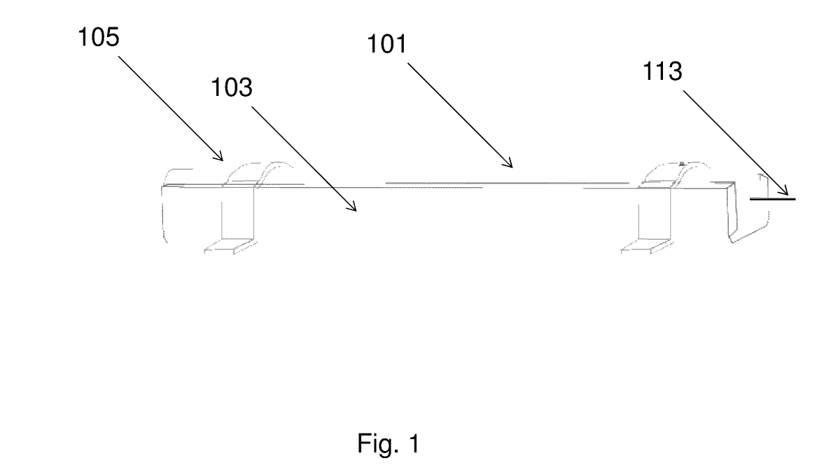

Referring to FIG. 1, one embodiment of the invented LED lighting system is depicted. LED lighting system is composed of LED lighting unit 101, mounting channel 103, mounting brackets 105 and power cord 113. Mounting channel 103 is usually U-shaped to be able to hold the LED lighting unit 101. However, any shape that will hold the LED lighting can be used. The mounting channel 103 will typically be sturdy, but it can be slightly flexible. Since it is the component that will attach to the structure from which the LED will illuminate, it has to have enough resiliency to allow for such an attachment. It can be made out of metals such as aluminum, but also be composed of softer materials such as rubber.

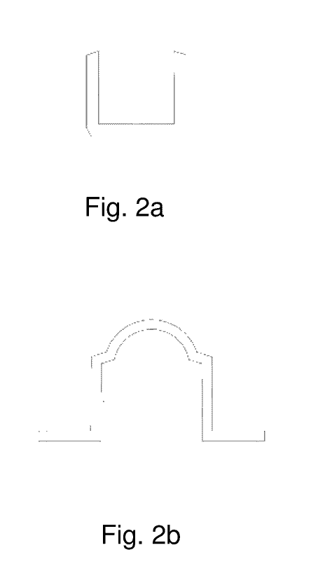

The mounting channel 103 typically is opaque as the LED lights will be directed to shine out of the U channel and not through the channel. Mounting brackets 105 are used to secure the LED lighting unit 101 in the mounting channel 103. The mounting brackets are not affixed to the LED lighting unit 101, but will secure the lighting unit in the mounting channel 103 by encircling the LED lighting unit 101 in the channel The mounting brackets will be transparent or translucent because it will cover the LED lighting unit in the direction from which the light is emanating. FIGS. 2a and 2b show side views of a standard mounting channel 103 and mounting bracket 105 respectively.

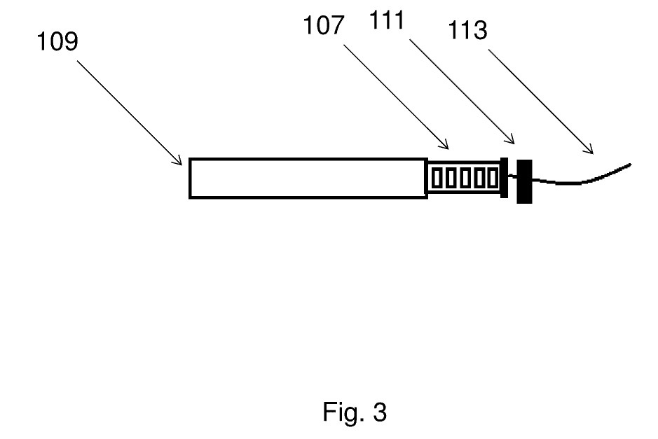

FIG. 3 depicts the LED lighting unit 101. LED lighting unit 101 will contain the LED ribbon strip 107 within the LED lighting cover 109. LED lighting cover 109 will have end caps 111 to enclose the cover with a hole for power cord 113. End caps are made of a durable opaque material so as to not allow any light from within the LED lighting cover to escape out through the ends of the LED lighting unit 101. FIG. 3 shows the LED ribbon strip 107 partially extended out from the LED lighting cover 109.

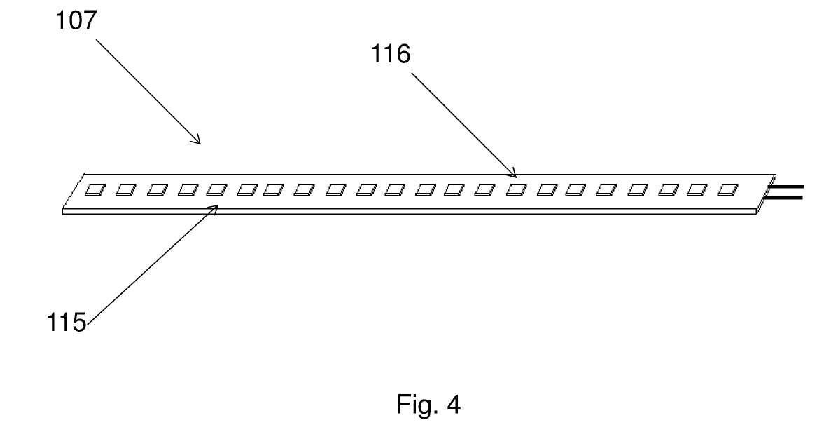

LED ribbon strip 107 is shown in greater detail in FIG. 4. LED ribbon strip 107 is composed of a substrate 115, LED chips 116 and some electronic components to support the LED chips. Substrate 115 will generally be shaped in a flat plane and be composed of some insulated conducting material. A preferred conducting material is copper, but any printed circuit board that could house LEDs and be conductive to pass current through to the LEDs would still be in the scope of the invention.

LEDs will be mounted on top of the plane of the substrate and will be positioned to emit light in generally the same direction. LEDs can alternatively be mounted on both sides of the LED ribbon strip. Different types of LEDs can be placed on LED ribbon strip. For example, different colors, sizes and configurations can be used and still be in the scope of this invention.

LED ribbon strip 107 is designed to be flexible and can be curved in many different directions. The degree in which the LED ribbon strip 107 can flex in any directions will vary depending on the flexibility of the material. However, in general, the LED ribbon strip is capable of curving the most in the direction that is orthogonal to the plane of the substrate along the length of the strip. This direction is referred to as curving up and down lengthwise. Likewise, the LED ribbon strip is capable of curving the least in the direction parallel to the plane of the substrate along the length of the strip. This direction is referred to as curving in a side to side motion. Although capable of twisting the LED ribbon strip or curving the LED ribbon strip in the orthogonal direction to the plane of the substrate along the width of the strip (curling up widthwise), neither of these capabilities are encouraged as it can hamper the illumination effected by the LEDs. Twisting the LED strip will misalign the LEDs light direction and curling the LED ribbon strip widthwise has the potential to cover some of the light being emitted from the LEDs.

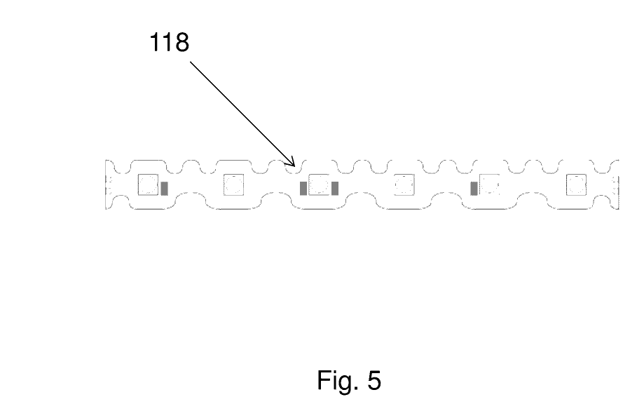

FIG. 5 shows an alternate configuration of the LED ribbon strip. LED ribbon strip 107 will have cutouts 118 along the side of the substrate. Such cutouts will additionally assist with the flexibility of the LED ribbon strip in flexing from side to side as the cutout sections will give the strip room to bend into when being flexed.

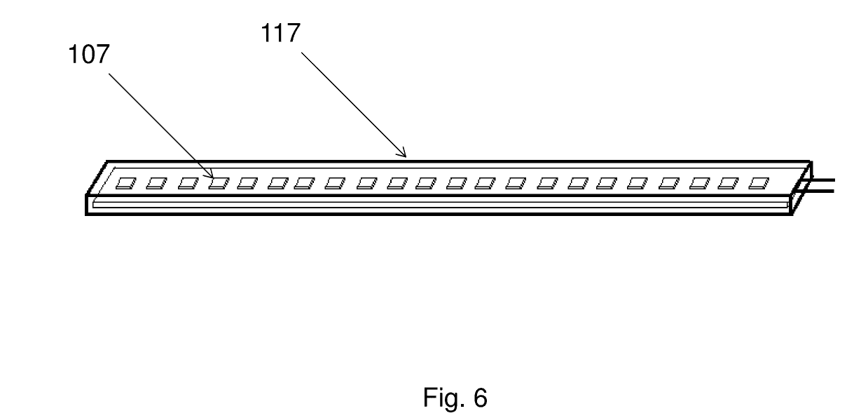

FIG. 6 depicts an LED ribbon strip enclosed within a sleeve 117. Although capable of being used without a protective sleeve 117, LED ribbon strip 107 can also be inserted into protective sleeve 117 prior to being inserted into the LED lighting cover 109. The LED ribbon strip 107 can be inserted inside the sleeve 117 through one end and the sleeve 117 can be pulled over the LED ribbon strip.

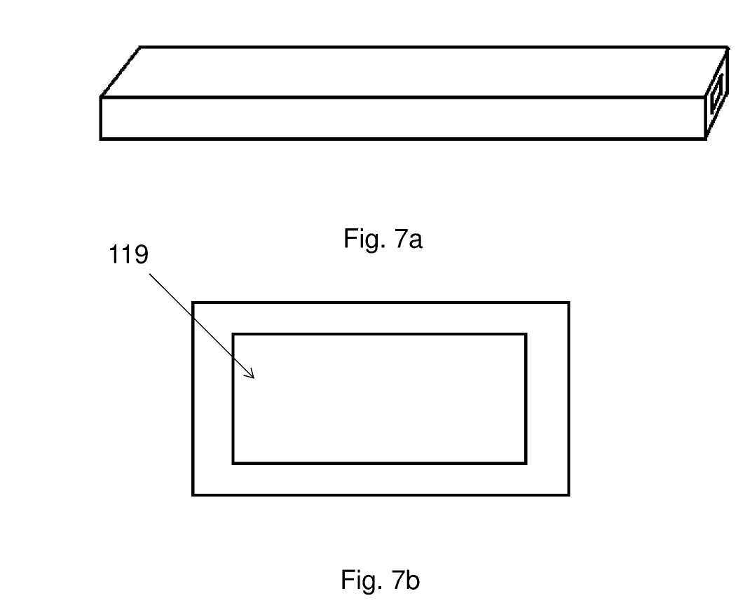

Depicted in FIGS. 7a and 7b, sleeve 117 will be an interim housing for the LED ribbon strip 107. Sleeve 117 will have a channel 119 contained within it that will be big enough to hold the LED ribbon strip 107, but not large enough that the LED ribbon strip can twist very much within the channel 119 so as to misalign the LEDs on the strip. The LED ribbon strip 107 should be able to twist slightly within the sleeve. The range of twisting should not greatly misalign the LEDs on the strip which can have a negative effect on the overall light emanating from fixture.

The ability of the LED ribbon strip to twist slightly within the sleeve allows the sleeve to flex from side to side more than it would be able to without damaging the strip inside. As the sleeve is flexed side to side, the LED ribbon strip can twist slightly within the sleeve. Consequently, the twisted LED ribbon strip will no longer be flexing in a completely side to side motion, but rather will be partially flexing side to side and partially up and down. This expands the sleeve's range of motion to flex side to side without damage to the strip.

While the sleeve 117 should be flexible enough to curve along with the LED ribbon strip 107, it also will provide support for the LED ribbon strip 107 to protect it from bending, kinking or tearing. Since the width of the sleeve is longer than the height of the sleeve, that differential will generally inhibit the sleeve 107 and the LED ribbon strip 117 from bending side to side. This inhibition will further protect the LED ribbon strip from tearing if the LED ribbon strip is curved sideways. The limited range of flexibility of the sleeve in the side to side direction should be within the tolerances of the internally twisted LED ribbon to flex partially side to side and partially up and down. In addition, the resistance to bending side to side will also cause any curvature of the sleeve to be more gradual along the length of the strip and it is less likely to kink or bend dramatically in one place which would damage the LED ribbon strip. While the thickness of the walls of the sleeve is shown as being uniform, the thickness of the walls can vary. For example, the top wall can be made thicker than the bottom to inhibit flexion in a particular direction in the up down direction.

Sleeve 117 will usually be transparent to not have any loss of light due to diffraction. The exterior shape of the sleeve is shown as rectangular to accommodate the LED ribbon strip within, but it can be any shape that will fit into the LED lighting cover 109. It would be preferable to have a uniform size and shape for the exterior surface with different sizes and shapes for the interior channel. This would standardize the system as different sizes and shapes of LED ribbon strips can then be utilized with LED lighting covers with a standard internal channel. If the exteriors of the sleeves were a uniform size and shape, then different sized and configurations of LED ribbon strips can be used with different LED lighting covers simply by using sleeves that have a particularly sized interior channel to accommodate the particular size of the LED ribbon strip and the standard exterior size to fit into a standardized LED lighting cover. This would have an advantageous effect since the sleeves are relatively less expensive than the LED ribbon strip.

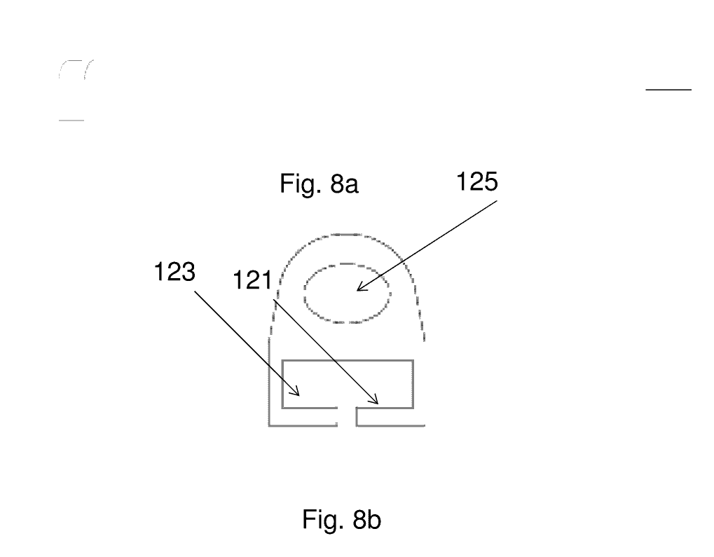

LED lighting cover 109 is depicted in FIGS. 8a and 8b. LED lighting cover 109 is a tube like cover that will be designed to fit over the LED ribbon strip 107 with or without sleeve 117. Referring to FIG. 8b, the LED lighting cover 109 will have a dome shaped top with a flat bottom. The bottom will be flat to fit into a mounting channel 103 but can be any shape appropriate for the channel The bottom of the cover will have inserts that are designed to hold the LED strip. The inserts depicted in FIG. 8b are two tabs 121 at either side of the cover that will have an internal cover channel 123 designed to hold the LED ribbon strip with or without the sleeve 117. The tabs 121 should have sufficient rigidity to hold the LED ribbon strip in the cover. However, the tabs should be flexible enough to operate along with the spacing between the tabs to allow the LED ribbon to be easily inserted into the internal cover channel. The user can insert the LED ribbon strip by sliding the LED ribbon strip into the channel from one end or alternatively peeling back the tabs and placing the LED ribbon strip into the channel from the bottom. Alternative design for the bottom of the LED lighting cover can be utilized as long as it can fit in the mounting channel and retain the LED ribbon strip in the channel

The internal cover channel will be rectangular in shape to accommodate the shape of the exterior of the sleeve 117 or the shape of the LED ribbon strip without the sleeve. The fit with the LED ribbon does not have to be particularly snug and there can be room between the walls and the contained unit, but it should not allow the LED ribbon to twist in the channel nor allow the LED ribbon to curl up widthwise within the channel. The channel can be made into standard size so that any sleeves that have the standard exterior shape and size can be easily inserted into the channel.

The top portion of the LED lighting cover 109 is in the shape of a dome. The domed surface will be the facade through which the LED light will be emitting. The dome shape assists in creating a uniform continuous glow to the multiple LED lights due to its shape because the surface will be generally equidistant from any particular LED source. However, other shapes other than a dome shape can be utilized that will be within the scope of the invention.

The domed top section will have a continuous cavity 125 through the section that will continue throughout the length of the cover. The cavity 125 is shown to be oval in shape because the exterior is dome shaped, but other shapes of the cavity can be utilized and still be within the scope of the invention.

The cavity 125 will be completely separated from the channel that houses the LED ribbon strip. The effect of having a separate cavity above the LEDs is that the light will be spread more evenly in the cavity 125. By having the light spread more evenly throughout the cavity, the light emitted through the cover will have a continuous glow of light without any points of light or hot spots. A viewer will see the entire dome shaped cover light up evenly. Having the cavity be uniform throughout the top portion of the cover also helps ensure an even emission of light through the cover. Alternatively, the cavity can be non-uniform through the length of the strip to accommodate those situations where the LEDs are not evenly spread on the strip. Such a non uniform cavity will be implemented to ensure the even blending of the light. The cavity above the LEDS will also aid in heat dissipation caused by the LEDs generating light.

The LED lighting cover 109 will be translucent and will diffuse the light that passes through it. The opacity of the material will be dependent on the strength of the LED light, but it should be opaque enough so that the light diffuses while travelling through it. The thickness of the walls comprising the cavity 125 should be thick enough to aid in diffusion of the light, but thin enough to allow ample light to pass through it in order to operate as a lighting unit.

The LED lighting cover 109 will be composed of a durable, but flexible material. The LED lighting cover will be capable of curving in all directions, including curving from side to side and from top to bottom. When being curved, the LED lighting cover will curve gradually throughout the length of the cover and not bend or kink in any particular point which will further protect the LED ribbon strip. The thickness of the walls surrounding the cavity and the channel will also aid in preventing the cover from bending or kinking. The LED lighting cover is preferably composed of silicone, but other materials can be used and still be within the scope of the invention.

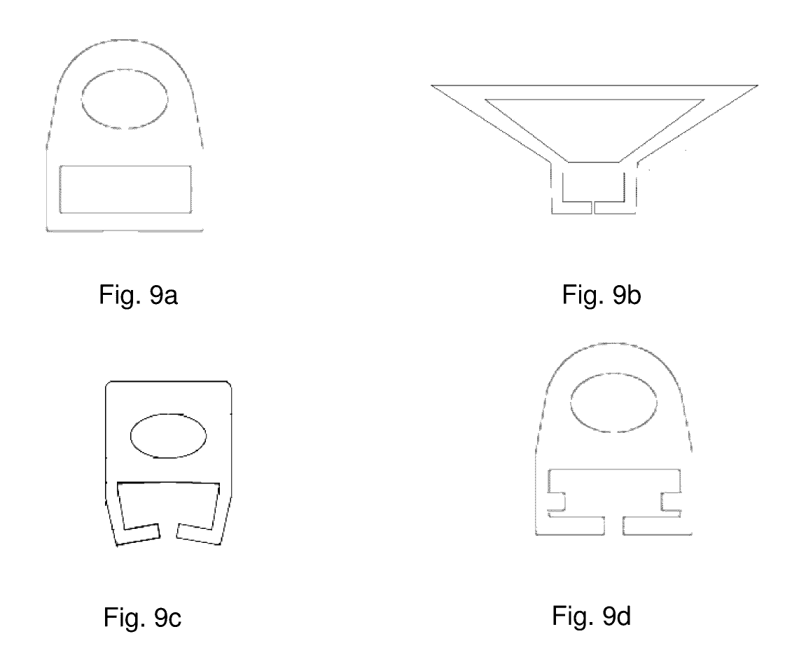

FIG. 9a depicts an LED lighting cover with a completely enclosed bottom section that encloses the internal channel. In this embodiment, the LED ribbon strip will be inserted into the channel from the end and will slide into the channel.

FIG. 9b depicts a different shape to the top section of the LED lighting cover. The LED lighting cover in FIG. 9b has an inverted triangular top with a matching internal cavity. FIG. 9c depicts an LED lighting cover that has a flat top to the top section of the LED lighting cover. The internal cavity is being depicted as oval in shape. As can be seen in FIGS. 9b and 9c, the internal cavity does not have to match the shape of the top, but can be any shape and be within the scope of the invention.

FIG. 9d depicts an internal channel of the LED lighting cover that has grooves to specifically accommodate the LED ribbon strip without a sleeve. The LED lighting cover will have a special tab that will create a groove that assist in sliding the LED ribbon strip into the channel and further prevent the LED ribbon strip from curling widthwise or twisting in the channel.

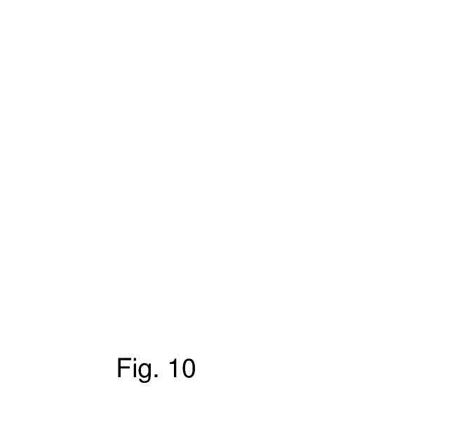

FIG. 10 shows the LED lighting unit being flexible in different directions. The curvature of the LED lighting unit is different throughout the unit and the curvature is gradual.

What is claimed is:

1. A cover for an LED lighting strip, comprising:
an elongated body; said body having a top section and a bottom section; said top section housing an internal cavity; said bottom section housing a channel; said channel housing the LED lighting strip; wherein the LED lighting strip emits light into said internal cavity and out of the cover through said top section.

2. The cover for an LED lighting strip as recited in claim 1, wherein the internal cavity will extend throughout said elongated body along the length of the body.

3. The cover for an LED lighting strip as recited in claim 1, wherein said elongated body is composed of silicone.

4. The cover for an LED lighting strip as recited in claim 1, wherein the top section if shaped as a dome.

5. The cover for an LED lighting strip as recited in claim 1, wherein the top section is shaped as a rectangle.

6. The cover for an LED lighting strip as recited in claim 1, wherein the top section is shaped as an inverted triangle.

7. The cover for an LED lighting strip as recited in claim 1, wherein said elongated body is flexible.

8. The cover for an LED lighting strip as recited in claim 1, wherein said channel allows the LED lighting strip to slightly twist within said channel.

9. The cover for an LED lighting strip as recited in claim 1, wherein said elongated body is composed of a translucent material.

10. The cover for an LED lighting strip as recited in claim 1, further comprising a sleeve that encapsulates the LED lighting strip when housed in the channel.

11. The cover for an LED lighting strip as recited in claim 10 wherein said sleeve is flexible.

12. The cover for an LED lighting strip as recited in claim 10 wherein said sleeve has an internal channel and the LED lighting strip is placed in the internal channel.

13. The cover for an LED lighting strip as recited in claim 12 wherein said internal channel allows the LED lighting strip to slightly twist within said internal channel when said sleeve is flexed from side to side.

14. A cover for an LED lighting strip, comprising:
an elongated body; said elongated body housing an internal cavity and a channel; said internal cavity located above and separate from said channel; wherein said channel houses the LED lighting strip and the LED strip emits light into said internal cavity and out of said cover through said cavity.

15. The cover for an LED lighting strip as recited in claim 14, further comprising a sleeve that encapsulates the LED lighting strip when housed in the channel.

16. An LED lighting system, comprising:
an LED ribbon strip having LEDs to emit light; and
an LED lighting cover having a top section, an internal channel and a cavity;
wherein said internal channel will house the LED strip; said cavity will be located in the top section and positioned above the internal channel such that the LEDs being housed in said internal channel will emit the light to enter the cavity and shine through the top section of the LED lighting cover.

17. The LED lighting system as recited in claim 16 further comprising a sleeve; said sleeve being flexible and encapsulates said LED ribbon strip in an interior channel;
said interior channel large enough to allow said LED ribbon strip to twist within said interior channel when said sleeve is flexed from side to side.

18. The LED lighting system as recited in claim 16 wherein said LED ribbon strip will have cutout sections within the strip to facilitate bending from side to side.

19. The LED lighting system as recited in claim 16 wherein the cover is composed of silicone.

20. The LED lighting system as recited in claim 16 wherein said cover is flexible and said LED lighting system is capable of flexing from side to side without damaging the LED ribbon strip.
